(19) United States
(12) Patent Application Publication
(10) Pub. No.: US 2026/0064597 A1
(43) Pub. Date: Mar. 5, 2026

(54) SPLIT-ENTRY DRAM CACHE

(71) Applicant: Rambus Inc., San Jose, CA (US)

(72) Inventors: Michael Raymond Miller, Raleigh, NC (US); Wendy Elsasser, Austin, TX (US); Brent Steven Haukness, Sunnyvale, CA (US); Taeksang Song, San Jose, CA (US); Steven C. Woo, Saratoga, CA (US)

(21) Appl. No.: 19/108,328

(22) PCT Filed: Sep. 5, 2023
(86) PCT No.: PCT/US2023/031998

§ 371 Date: Mar. 3, 2025

Related U.S. Application Data
(60) Provisional application No. 63/405,409, filed on Sep. 10, 2022.
(60) Provisional application No. 63/471,247, filed on Jun. 5, 2023.

(51) Int. Cl. G06F 12/0895; G06F 12/0831; G06F 12/0879

(52) U.S. Cl. CPC G06F 12/0895; G06F 12/0833; G06F 12/0879

(57) ABSTRACT

A high-capacity cache memory is implemented by one or more DRAM dies in which individual cache entries are split across multiple DRAM storage banks such that each cache-line read or write is effected by a time-staggered set of read or write operations within respective storage banks spanned by the target cache entry.

### CROSS-REFERENCE TO RELATED APPLICATIONS

This application hereby incorporates by reference and claims the filing-date benefit of U.S. Provisional Application No. 63/405,409 filed Sep. 10, 2022 and U.S. Provisional Application No. 63/471,247 filed Jun. 5, 2023.

### TECHNICAL FIELD

The disclosure herein relates to integrated-circuit data storage and more specifically to dynamic random access memory (DRAM) cache architecture and operation.

### DRAWINGS

The various embodiments disclosed herein are illustrated by way of example, and not by way of limitation, in the figures of the accompanying drawings and in which like reference numerals refer to similar elements and in which:

FIG. 1 illustrates an exemplary data processing system having a host processor 101 coupled between a backing storage and a DRAM cache (CDRAM);

FIG. 2 illustrates an exemplary operational sequence within the CDRAM of FIG. 1 upon registering a cache read command and corresponding address;

FIG. 3 illustrates an exemplary access-control architecture within a four-way set-associative CDRAM embodiment;

FIG. 4 illustrates exemplary result-dependent actions executed within the FIG. 1 CDRAM embodiment in response to host-supplied read, write, fill and flush commands

FIG. 5 illustrates an exemplary operational sequence executed by the FIG. 3 cache controller in response to a cache read command;

FIG. 6 illustrates an embodiment of page-buffer access circuitry having dual input/output (IO) connections to a DRAM bank sense amplifier/page buffer;

FIG. 7 illustrates an operational sequence similar to that in FIG. 5, but with successive cache read operations directed to different bank pairs;

FIG. 8 illustrates an embodiment of a CDRAM (in part) having a heterogenous DRAM core architecture;

FIG. 9 illustrates an exemplary mapping of tag and index fields of a 50-bit (pebibyte) address that may be applied in various CDRAM embodiments herein; and

FIG. 10 illustrates an embodiment of LRU (least-recently-used) update circuitry that may be deployed within the various CDRAM implementations presented herein.

### DETAILED DESCRIPTION

In various embodiments herein, a high-capacity cache memory is implemented by one or more DRAM dies in which individual cache entries are split across multiple DRAM storage banks such that each cache-line read or write is effected by a time-staggered set of read or write operations within respective storage banks spanned by the target cache entry. In a number of embodiments, each cache entry is split (or striped or distributed) across paired banks disposed within respective (different) bank groups, with each constituent bank of the pair storing a respective half of the cache line together with a respective portion of tag-match/cache-line replacement information. In one implementation, for example, each entry-spanned bank pair is constituted by one bank within an even-numbered bank group (the “even bank”) and another bank within an odd-numbered bank group (“the odd bank”), effectively pairing the bank groups themselves so that every incoming cache request triggers staggered memory access operations—for example, staggered by a minimum time between row activations in different bank groups—in both the odd bank/odd bank group and even bank/even bank group. In those cases, the DRAM access circuitry may be architected such that the time-staggered memory access operations enable back-to-back transfers (i.e., no timing gap or bubble) of the respective cache-line halves read out from or to be written to the even and odd storage banks. Accordingly, from the perspective of a host device (e.g., processor or other cache-line read/write requestor), a complete cache line is transferred in continuous data burst over the data links extending between the host device and CDRAM—a particularly beneficial arrangement in the context of a DRAM core having a native data input/output (I/O) width smaller than the cache line requested by the host device. In a number of embodiments, for example, the CDRAM core transacts core read and write operations with 32-byte (32B) granularity but is coupled to one or more processor cores architected to read and write 64B cache lines. In those cases, the dual, time-staggered access operations implemented internally within the CDRAM enables back-to-back 32B data transfers and thus, collectively, a full 64B cache line read or write, thus meeting the 64B cache line granularity demanded by individual processor core(s). In other embodiments, tags and associated cache control information (e.g., various status bits used to indicate cache line validity, coherency (clean vs. dirty), support for one or more replacement policies (e.g., least recently used, ‘LRU’ field), etc.) are also fractionally stored in respective storage banks with, for example, address tags and status information required to ascertain cache hit/miss stored together with corresponding cache-line halves in one storage bank, and cache-line usage information (i.e., provided to support cache line eviction/replacement) stored together with cache-line latter halves in the counterpart storage bank. Such arrangement, together with circuitry for rapidly comparing address-specified tags (i.e., extracting those tags and associated status data from an activated (open) DRAM page within the tag-address storage bank) with the tag field of the host supplied cache-line address, enables cache hit/miss determination (and corresponding notification to the access requestor/host device) exclusively from content within the initial one of the two time-staggered storage bank accesses—for example, without awaiting completion of the latter storage bank access and thus at the earliest possible time. In those and other embodiments, individual DRAM storage banks may include bifurcated DRAM array access circuitry, with full duplex data input/output (IO) signaling paths (and corresponding full-duplex internal IO lines—global IO lines) and associated read/write circuitry provided with respect to tag and entry-status sub-fields to maximize transactional concurrency—e.g., enabling hit/miss output together with victim tag address (i.e., tag corresponding to cache line slated for eviction) concurrently with incoming search tags (i.e., the latter accompanying a cache line read/write request)—while smaller-footprint bidirectional I/O signaling paths are provided with respect to much larger cache line sub-fields to preserve die area and power. In yet other embodiments, individual storage banks are implemented with heterogenous DRAM cores, for example, with smaller mat sizes and/or larger DRAM storage cells implemented in the portion of the core allocated for tag/entry status to yield faster activation (buffering within sense amplifiers) with respect to that time-critical data (i.e., enabling more rapid hit/miss determination), and with larger mat sizes and/or smaller DRAM storage cell sizes implemented within the cache-line-storage portion of the core to maximize storage density. These and other embodiments are described in greater detail below.

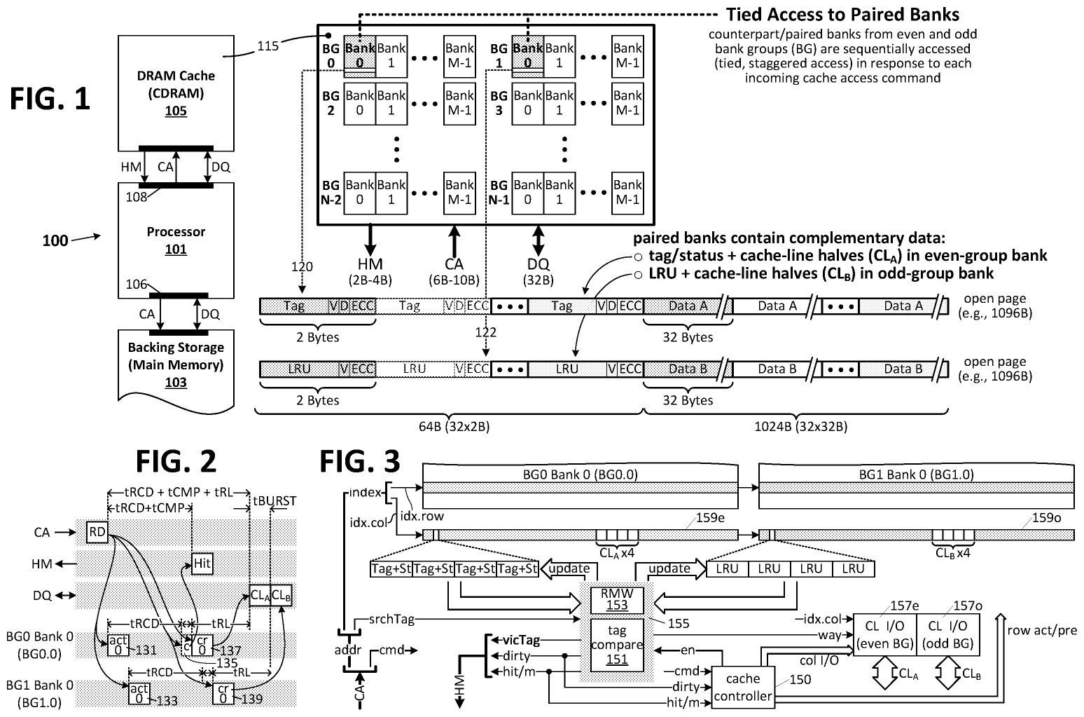

FIG. 1 illustrates an exemplary data processing system 100 having a host processor 101 coupled between a backing storage 103 (e.g., operating memory or main memory) and a DRAM cache (CDRAM) 105. The host processor (e.g., multi-core graphics, general-purpose or special-purpose processor, or more generally any integrated circuit component capable of issuing memory/cache access instructions) includes a memory-control interface 106 to issue command/address values to and exchange data with backing store 103 (i.e., via command/address links (CA) and data links (DQ), respectively), the latter implemented by one or more DRAM memory modules (e.g., one or more dual inline memory modules (DIMMs)), static random access memory (SRAM) memory components, nonvolatile memory components (e.g., flash memory), and/or any other practicable memory components (including mechanically-accessed storage media).

Host processor 101 also includes a cache memory interface 108 to issue cache read/write commands and associated memory addresses to CDRAM 105 via command/address (CA) links, receive hit/miss and associated information (e.g., entry status, victim tag address, etc.) from the CDRAM via a dedicated hit/miss bus (HM), and output/receive cache lines to/from the CDRAM via cache-line data links (DQ). For example, CDRAM 105 responds to a read or write hit (i.e., determination by cache-control circuitry within CDRAM 105 that a cache line corresponding to an address supplied by host processor 101 with a cache read or write request is indeed stored within the CDRAM) by returning a requested cache line to host processor 101 via the DQ links (cache read) or writing a cache line received from the host processor via the DQ links into an address-indicated cache-line entry (cache write). CDRAM 105 may similarly output a victim cache line via the DQ links in conjunction with a dirty cache miss—a determination conveyed to host processor via the hit/miss bus that an address-specified cache line is not stored within the CDRAM (cache miss) and that a victim cache line within the CDRAM (i.e., a cache line to be overwritten with a host-supplied cache line corresponding to the original cache access request) has or may have been modified relative to a counterpart copy of the cache line within backing store 103 (i.e., is “dirty”) and is thus to be “evicted” from the CDRAM to backing store 103 (and therefore output from the CDRAM via the DQ links, in some cases after temporary buffering/queuing within the CDRAM to avoid contention with one or more inbound cache lines). Conversely, the host processor may output a cache line and corresponding fill instruction (via DQ links and CA links, respectively) in response to a read miss clean response from the CDRAM (i.e., CDRAM signaling a cache miss via the hit/miss bus together with status information indicating that a new cache line may be loaded into the CDRAM without evicting a resident cache line—that is, a cache line corresponding to the index field of the address supplied with the cache read request is unmodified (coherent) with respect to a counterpart copy within backing store 103 (i.e., cache line is “clean”) and thus may be overwritten without eviction and/or that one or more CDRAM entries corresponding to the index field are unoccupied/invalid).

In the FIG. 1 embodiment, the DRAM storage core within CDRAM 105 is organized hierarchically in N groups of M storage banks in which each storage bank has a native data IO (input/output) width smaller than the cache line size expected by host processor 101—for example, a 32-byte (32B) per-bank input/output (IO) data width as opposed to a 64B cache-line size established by circuitry (possibly including one or more lower-level cache memories) within the host processor. Access control circuitry within the CDRAM hides this data size discrepancy from the host processor by executing row activation and column access operations in two counterpart DRAM banks in response to a given cache access request—an operation referred to herein as a “tied” access to paired banks—with each individual bank access reading/writing a respective half of an address-indicated cache line (at least in the case of a cache hit) with internal CDRAM timing so as to enable back-to-back transfers of each 32B cache-line half (or cache line fragment) over the DQ bus. By this operation, CDRAM 105 presents to the host processor as a 64B granularity cache despite its 32B native access granularity, responding to a cache read request (at least in the case of a cache hit) by outputting a complete 64B cache line to the host processor over the DQ links in back-to-back 32B bursts (each 32B cache line fragment being retrieved from a respective one of an address-selected pair of banks) and likewise responding to a cache write request by receiving a complete 64B cache line transmitted (by host processor 101) in back-to-back 32B bursts and, at least in the case of a cache hit, writing the 32B cache line halves to respective banks within the address-indicated bank pair. While such back-to-back 32B bursts (emulating a continuous 64B cache line read or write burst) are described in connection with various CDRAM embodiments herein, in all cases the individual per-bank input/output data burst (i.e., individual 32B bursts in examples herein, though larger or smaller per-bank bursts may be implemented) may be temporally offset from one another (i.e., nonzero time interval elapses between conclusion of initial burst and commencement of latter burst). In some embodiments, for example, the per-bank data (cache-line-fragment) bursts corresponding to two or more cache access requests may be interleaved such that conveyance (between CDRAM 105 and host processor 101) of the initial cache line fragment for a first cache access request is followed by conveyance of the initial cache line fragment for a second cache access request and then by conveyance of a latter cache line fragment for the first cache access request (and then by conveyance of a latter cache line fragment for the second cache access request) such that the initial and latter cache line fragments for the first cache access request are offset at least by the time interval required for conveyance of the initial cache line fragment for the second cache line access.

In one embodiment, a cache controller within CDRAM 105 implements tied (paired-bank) access by executing time-staggered, temporally overlapping memory operations with respect to counterpart banks in different/respective bank groups-an approach that minimizes delay between successive row activations (a lesser delay than required between successive activations within different banks in the same bank group, for example) and thereby enables back-to-back 32B IO operations (and thus a continuous 64B cache line burst) with minimal latency (e.g., the initial bank access need not be delayed to align data output with that of the latter bank access). In a more specific implementation, shown for example in detail view 115, the cache controller responds to an incoming cache read/write request by commencing a leading access within a bank in an even-numbered bank group (e.g., bank 0 within bank-group 0) and then, prior to concluding the leading access, commencing a trailing access within a bank in an odd-numbered bank group (bank 0 within bank-group 1).

Still referring to detail view 115, the leading and trailing accesses each include a respective row activation—transferring contents within an address-specified row of storage cells (memory page) to a sense amplifier bank (page buffer)—and a respective column access operation to access an address-specified portion of the data resident within the sense amplifier bank (open memory page). In a number of embodiments, cache line halves are stored within individual memory pages together with corresponding cache tags and related status information, with the latter split between two paired-bank memory pages such that cache tags and status information used to assess cache hit/miss are resident with the leading memory page (the memory page activated in the leading bank access) and the remaining status information (e.g., used to manage cache line replacement) is resident within the trailing memory page. Through this architecture and data organization, the leading and trailing row activations (i.e., component operations of the leading and trailing accesses within an address-selected bank pair) render all information needed to complete a host-requested cache access into a pair of open memory pages and also enable determination of cache hit/miss at the earliest possible time—for example, enabling tag compare to commence before the trailing-access memory page becomes available (open) or at least without awaiting completion of the trailing-access row activation.

Exemplary data organizations within leading and trailing memory pages (i.e., opened in leading and trailing memory access operations within respective DRAM banks disposed in diverse—even and odd—bank groups) are shown at 120 and 122 within FIG. 1 detail view 115. In the depicted example, tag address values and corresponding validity and coherency indicators (e.g., valid bit, ‘V’, and dirty bit, ‘D’) corresponding to respective cache lines are co-located with first-halves of those cache lines (and optionally with error-code-correction (ECC) values) within the leading memory page (120), while a set of recency and validity indicators corresponding to the same cache lines are co-located with counterpart-halves of those cache lines within the trailing memory page (122). Through this arrangement and by architecting the column access circuitry to enable split access at least to the leading memory page, information required for cache hit/miss assessment is resident entirely within the leading memory page (i.e., becomes available at the earliest possible time) and the overall storage of cache lines, cache line tag addresses, cache line status information (e.g., validity, coherency, usage recency) and ECC information is balanced between the leading and trailing memory pages so as to enable maximized cache line storage per bank pair. In the depicted example, for instance, leading memory page 120 is constituted by respective halves of 32 64B cache lines (i.e., each 32B cache line half depicted as “Data A” or “CLA”) and 32 2-byte hit-assessment vectors corresponding one-for-one to those 32 cache lines, while trailing memory page 122 is constituted by remaining halves of the 32 cache lines and 32 2-byte cache-line replacement vectors that also correspond one-for-one to the 32 cache lines-thus, two (leading and trailing) 1096B memory pages in this example. As shown, each two-byte hit-assessment vector includes a tag address (part of the full backing-store address of the corresponding cache line), validity indicator (e.g., “valid” bit ‘V’ indicating whether the corresponding cache line storage field is occupied by a valid cache line and thus, inversely, whether the cache line entry is empty), coherency indicator (e.g., “dirty” bit ‘D’ indicating whether the corresponding cache line has been modified/is dirty relative to a counterpart instance within backing store 103) and optional ECC information. Each two-byte cache-line replacement vector includes a multi-bit recency value-indicating, for example, the least recently used (LRU) cache line among an indexed set of cache lines (the recency value is referred to herein as an ‘LRU’ value although other usage metrics/statistics may be used, for example, in accordance with a programmably specified cache line replacement policy) together with an entry-valid bit (V) and optional ECC information. Various other cache-line status/characterizing information may be stored within the cache-line memory pages in alternative embodiments, and the bit-depth and organization of the depicted hit-assessment/replacement vectors may be different from that shown (e.g., each vector co-located with its corresponding cache-line fragment within the page buffer).

FIG. 2 illustrates an exemplary operational sequence within the FIG. 1 CDRAM upon registering a cache read command (RD) and corresponding address—a command/address value issued by the host processor via the command/address bus (CA). As shown, the CDRAM responds to the cache read command by executing concurrent, time-staggered accesses (tied accesses) to paired banks specified by one or more address fields within the incoming address, commencing (in this example) leading and trailing row activation operations (131, 133) within bank 0 of bank-group 0 and bank 0 of bank-group 1 (i.e., bank pair BG0/1.0 constituted by banks BG0.0 and BG1.0). Each row activation operation spans a time interval tRCD (delay between row-address strobe and column-address strobe) as an index field of the host-supplied address value is applied to activate a selected row of storage cells within each bank of the bank pair, transferring contents of those rows to respective per-bank sense amplifiers (IO sense amplifiers) to open leading and trailing memory pages as discussed above. Upon opening the leading memory page (i.e., completing the leading row activation operation and thus after the leading tRCD interval transpires), the cache controller initiates a tag-compare operation 135, enabling a tag comparator within the CDRAM to compare an address-selected “set” of hit-assessment vectors—a “tag set” containing a predetermined number of different tags that share the same index and thus multiple ways to yield a cache hit—with a tag field (“search tag”) within the host-supplied address value to determine whether the requested cache line is stored within the pair of activated memory pages and thus, whether a cache hit or miss has occurred. Accordingly, the CDRAM drives a hit/miss indication (a hit in this example) onto the hit/miss bus a predetermined time after receipt of the cache read command (i.e., tRCD plus compare interval, tCMP) and, at least in the FIG. 2 embodiment, prior to completion of the trailing row activation operation. In the depicted example, the cache controller responds to the cache hit by executing a column read operation 137 within the leading memory page (“cr0”) and then, when the trailing row activation completes, a column read operation (139) within the trailing memory page to output counterpart cache line halves (corresponding to the tag-matching way) onto the DQ bus (CL_{A}, CL_{B}) and thus deliver the address-specified cache line to the host processor. In the example shown, the column read operations are staggered in time according to the time-stagger between the leading and trailing row-activation operations and also in accordance with the per-bank data burst interval over the DQ bus (i.e., time interval over which constituent bits of a given cache-line half is transmitted or received). Thus, the total latency of the cache access, measured at the CA and DQ interfaces of the CDRAM, is the sum of the row activation interval (tRCD), tag compare interval (tCMP) and column-read latency (tRL), with the total transaction time spanning that cache access latency (tRCD+tCMP+tRL) plus the back-to-back cache-line data burst intervals (2*tBURST, where ‘*’ denotes multiplication).

FIG. 3 illustrates an exemplary access-control architecture within a four-way set-associative CDRAM embodiment, including the aforementioned cache controller 150, tag comparator and read-modify-write engine 153 (shown collectively within a compare/RMW block 155), and paired-bank cache-line IO circuits 157e and 157o (one cache-line I/O circuit for a bank within an even-numbered bank group and another cache-line I/O circuit for a counterpart bank within an odd-numbered bank group and thus “even and odd” cache-line IO circuits for the constituent even and odd banks of an address-specified bank pair). In the depicted example, each incoming command/address value (CA) includes a cache access command (e.g., read, write, fill, etc.) and cache-line address (addr), the latter including search-tag and index fields (together with bank-group and bank selection fields, not specifically shown).

Cache controller 150 responds to host-issued cache commands (“cmd”) by asserting and deasserting control signals as necessary to implement per-bank row activations (i.e., as discussed above) and, in accordance with cache hit/miss results, cache line (CL) read and write operations and updates to associated vectors (e.g., overwriting tag field and/or updating dirty bit, valid bit, ECC information within selected hit-assessment vectors, updating LRU fields and ECC within selected cache-line replacement vectors, etc.). In the FIG. 3 embodiment, a row-address sub-field of the index (idx.row)—itself a component of the host-supplied cache line address—is applied in paired-bank row activation operations to open leading and trailing memory pages 159e and 159o, respectively, within the even and odd banks of the selected bank-groups and banks therein (BG0.0 and BG1.0 in this example). In embodiments where the number of cache lines within the open memory pages exceeds the set associativity (i.e., exceeds the number of ways that may yield a cache hit), a column sub-field of the index (idx.col) is applied to select an N-way tag set within the leading memory page (in the FIG. 3 example, a four-way tag set constituted by four hit-assessment vectors each including tag and status information “Tag+St”), delivering that tag set to tag compare circuit 151 and read-modify-write (RMW) engine 153. The tag compare circuit (tag comparator) compares the host-supplied search tag (“srchTag”) with the tags within the set of hit-assessment vectors, signaling a cache hit upon detecting a tag match and a cache miss otherwise, driving the hit/miss indication (“hit/m”) onto the hit-miss bus (HM) and back to the cache controller. In a read or write hit scenario (i.e., cache hit in response to a host-issued cache read or write command), tag comparator 150 also outputs a way address (“way”) corresponding to the tag-matching hit-assessment vector and thus indicating which of the four cache lines specified by idx.col is to be read out or overwritten, delivering the way address to column IO circuits 157e/157o to enable multiplexed readout of the host-requested cache line (cache read) or multiplexed writing of a host-supplied cache line from/to way-specified (and idx.col-specified) cache line storage regions of the open memory pages.

In the FIG. 3 example, the tag comparator applies LRU data within cache-line replacement vectors of the trailing memory page (i.e., when that page becomes available) to determine the way address of a cache line to be evicted in the case of a dirty miss—that is, a cache read or write miss in which the victim/to-be-replaced cache line (identified by LRU field comparison) is dirty—and also to identify the way to be overwritten with a host-supplied cache line in a write miss clean or cache-line fill operation, where no cache line eviction is required. Note that tag comparator 151 may respond to a read or write miss yielding a mix of clean and dirty ways (i.e., one or more ways dirty and one or more other ways clean) by signaling either a dirty miss (specifying a way address corresponding to a dirty way) or a clean miss (specifying a way address corresponding to an unoccupied way or clean way), for example, in accordance with programmed CDRAM configuration. When eviction is required (e.g., dirty miss), tag comparator 151 outputs the LRU-derived way address to column I/O circuits 157e/157o to enable victim cache line readout (the victim cache line may be temporarily buffered/stored within the CDRAM during a cache write to avoid contention with the inbound, host-supplied cache line) and applies the LRU way address to select a victim tag address from among the hit-assessment vectors read out of page 159e, outputting the victim tag address (vicTag) and dirty status indicator to the host processor via the hit/miss bus as shown. When enabled by the cache controller, RMW engine 153 overwrites contents within the hit-assessment vectors (e.g., new tag address during write miss or cache fill operation, clearing the dirty bit as necessary and setting the valid bit on a cache fill (new CL load) operation, setting the dirty bit in a cache write hit, etc.) and cache-line replacement vectors (e.g., setting one or more bits within the LRU field following a cache hit to indicate access recency, setting the valid bit and/or clearing legacy content within the LRU field on a cache fill operation, etc.).

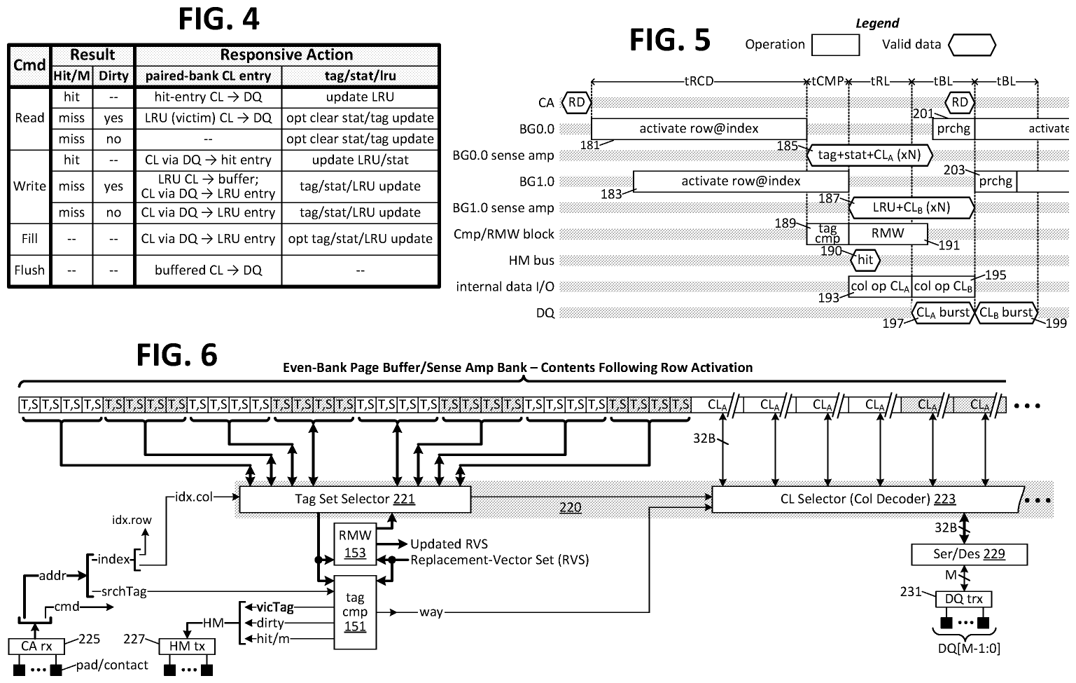

FIG. 4 illustrates exemplary result-dependent actions executed within the FIG. 1 CDRAM in response to host-supplied read, write, fill and flush commands. In the case of a read hit, the CDRAM retrieves a cache line (CL) from the hit-producing cache line entry (i.e., within leading and trialing memory pages), outputting that cache line via the CDRAM data interface (DQ) and updating the corresponding LRU field within the trailing memory page to reflect the cache line access. In a read dirty miss, the CDRAM retrieves a cache line from a victim cache line entry (i.e., at way address derived from LRU fields corresponding to the host-supplied cache line address), outputting the victim cache line (i.e., evicting the cache line) via the CDRAM data interface, updating the corresponding entry status field (e.g., clearing the valid bit to indicate that the subject cache line entry is no longer occupied) and optionally overwriting the tag field corresponding to the entry with the tag address supplied with the cache-read request (i.e., on expectation that the host will subsequently issue a fill instruction to load the requested cache line). In a read miss clean, the CDRAM may perform the same tag/status update operations without outputting the victim cache line, permitting that cache line—indicated to be coherent with respect to its backing-store counterpart—to be subsequently overwritten in a cache-fill operation.

The CDRAM responds to a write hit by transferring a host-supplied cache line to the hit-producing cache-line entry within the leading/trailing memory pages and updating the corresponding LRU and status information—for example, updating the coherency information for the cache line entry to reflect “dirty” status as the cache line write may (and likely has) modified the CDRAM-resident cache line relative to its backing-store counterpart. In the case of a write dirty miss, the CDRAM transfers an LRU-specified/victim cache line to an internal storage buffer (e.g., to avoid contention with the inbound host-supplied cache line and to allow later read-out by the host processor through issuance of a “flush” command) and then writes the host-supplied cache line (received via data interface, DQ) to the victim cache line entry—updating the tag address and status (e.g., valid, dirty) and LRU information corresponding to newly written cache line as shown. The CDRAM performs essentially the same write-miss operations in a write miss clean, except that the victim cache line is overwritten without eviction (i.e., no transfer of victim cache line to internal buffer). The CDRAM responds to a cache fill command by writing a host-supplied cache line (received via CDRAM data interface, DQ) to an LRU-identified entry as shown, and responds to a flush command by outputting a previously buffered cache line (e.g., evicted cache line stored within a FIFO or other temporary storage circuit within the CDRAM) to the host processor via data interface, DQ.

FIG. 5 illustrates an operational sequence executed by the FIG. 3 cache controller in response to a cache read command (“RD”). In the depicted example, the cache controller initiates time-staggered row activations at 181 and 183, opening leading and trailing memory pages within the BG0 and BG1 sense amplifier banks at 185 and 187. When the leading memory page becomes valid (i.e., after tRCD interval elapses), the cache controller initiates a tag compare operation 189 (e.g., issuing an enable signal to the tag comparator shown in FIG. 3), producing a cache hit/miss result (190) on the hit/miss bus shortly thereafter (i.e., after interval tCMP)—in this example, approximately when the trailing memory page becomes valid, thus making LRU data available to the read-modify-write engine as the cache controller receives the hit/miss result. In the depicted cache-hit example (signaling a hit at 190), the cache controller enables a read-modify-write operation (191) within the RMW engine to update LRU data for the way-specified cache line and also issues column address strobe (CAS) signals at 193 and 195 to trigger successive column-read operations within the open memory pages, reading-out respective halves of the way-specified cache line (CL_{A} from leading memory page, CL_{B} from trailing memory page) and transmitting those cache-line halves to the host processor in back-to-back burst intervals 197 and 199. After retrieving CL_{A} from the leading memory page, the cache controller asserts/deasserts row control signals as necessary to precharge the even DRAM bank (201) and thus close the leading memory page (commencing that precharge in this case prior to completion of the CL_{A} burst transmission—other timing may apply in alternative embodiments), and likewise precharging the odd DRAM bank (closing the trailing memory page) a short time later (203). As shown, the early precharge with respect to the leading memory page renders the even-bank page buffer available for a subsequent row activation operation (e.g., in response to another read operation issued to paired banks within the BG0/BG1 bank groups, allowing pipelined concurrency between successive operations directed to the same bank pair. As cache read/write transactions directed to other bank pairs within the same bank groups (BG0/BG1 in this example) and to other bank groups may be executed in a pipelined manner with those shown, the cache controller may render a steady stream of cache line traffic on the DQ bus (e.g., DQ bus fully occupied—no or few temporal gaps—by cache line transmission corresponding to a stream of CDRAM read/write requests) and a corresponding stream of hit/miss results on the hit/miss bus.

FIG. 6 illustrates an embodiment of page-buffer access circuitry having dual IO connections 220 to an even-bank sense amplifier (page buffer) in the form of a tag-set selector 221 and cache-line selector 223 that enable respective, concurrent access to the hit-assessment vectors and cache line fragments within a leading memory page (similar selector circuits may be provided with respect to the odd-bank sense amplifier to enable concurrent access to cache-line replacement vectors and cache line fragments within the trailing memory page). In the depicted example, tag set selector 221 selects a 4-way tag set specified by idx.col (received via command/address receivers 225) from among the eight 4-way tag sets resident within the open page, thus delivering a set of four hit-assessment vectors to tag comparator 151 and RMW engine 153 (a corresponding set of cache-line replacement vectors are delivered to the tag comparator and RMW engine by a counterpart selector for the odd-bank page buffer), each hit-assessment vector including a tag address and entry status data as discussed above (e.g., valid bit, dirty bit—ECC information may also be resident and applied within an error-detection-correction circuitry to correct bit errors within the selected tag set and corresponding cache line fragment). The tag comparator operates generally as explained above to render a hit/miss determination (i.e., comparing search tag with the tag-set tags) together with way address, victim tag address, clean/dirty status and possibly other status information as may be useful in a given CDRAM application, outputting same onto the hit/miss bus via hit/miss transmitters 227. The RMW engine also operates as discussed above to generate updated hit-assessment vectors and replacement vectors within the selected tag set/replacement-vector set (e.g., updating valid/dirty status upon cache write, updating LRU data according to way-specified cache line, overwriting tag address during cache write miss or fill operation, etc.).

Still referring to FIG. 6, the way address resolved by tag comparator 151 is supplied to column decoder 223 to enable read/write access to the corresponding cache-line fragment and thus, during a cache hit, commencement of data input/output with respect to that cache-line fragment at the earliest possible time—in some implementations even before the trailing memory page settles (becomes open) within the odd-bank memory page. By this operation, the leading cache-line half propagates through serializer/deserializer circuitry 229 (e.g., serializing a 32B cache-line fragment as necessary for transmission over the ‘M’ DQ links during a cache read for example) just as the trailing cache line half becomes available within the trailing memory bank, thus enabling back-to-back transmission/reception of the leading and trailing halves of the complete cache line with those two cache line halves propagating one after the other through the column decoder 223, serializer/deserializer circuitry 229 and data transceivers 231 (or in the reverse order in a cache write operation).

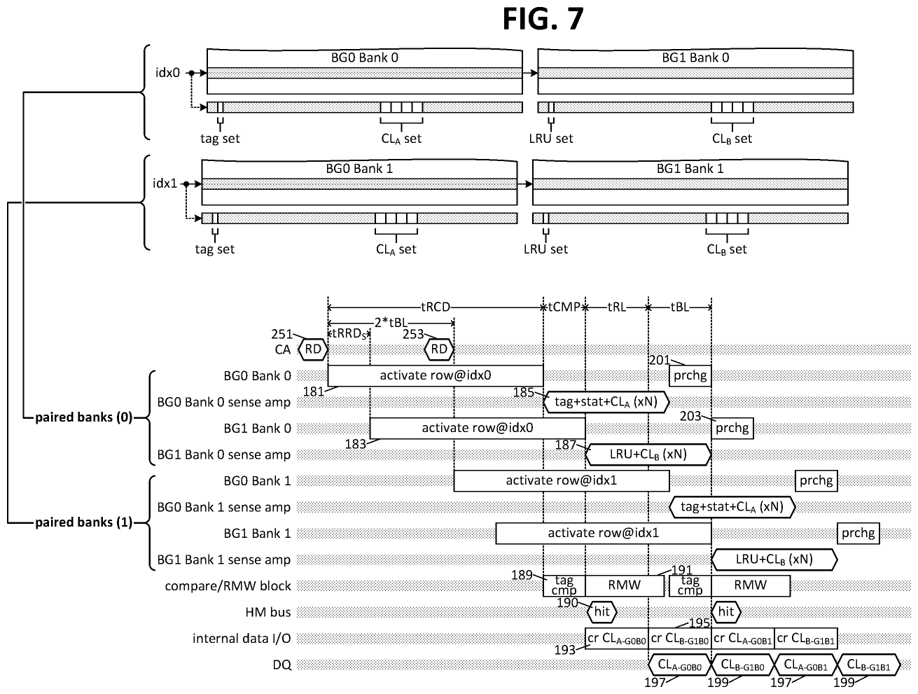

FIG. 7 illustrates an operational sequence similar to that in FIG. 5, but with successive cache read operations directed to different bank pairs. As in the FIG. 5 example, the cache controller responds to an initial cache read command by initiating time-staggered row activations at 181 and 183 to open leading and trailing memory pages within the BG0 and BG1 sense amplifier banks at 185 and 187—bank groups and banks specified by address fields within the host-supplied cache-line address. After the initial tRCD interval elapses (opening the leading memory page), the cache controller initiates a tag compare operation 189 to ascertain cache hit/miss, in this example signaling a cache hit on the hit/miss bus at 191 (i.e., after interval (CMP transpires) and enabling a read-modify-write operation within the RMW engine to update LRU data for the way-specified cache line at 191 (i.e., as the trailing memory page opens). The cache controller also issues column address strobe (CAS) signals at 193 and 195 to trigger successive column-read operations within the open memory pages, reading-out respective halves of the way-specified cache line (CL_{A-GOB0} from the leading memory page, CL_{B-G1B0} from the trailing memory page) and transmitting those cache-line halves to the host processor in back-to-back burst intervals.

Still referring to FIG. 7, the host processor issues a second cache read request 253 with a different paired-bank address (i.e., directed to bank 1 within BG0 and bank 1 within BG1 and thus BG0.1/BG1.1) a predetermined time after the initial BG0.0/BG1.0 read request and more specifically after an interval corresponding to the cache line burst interval, 2*tBL. The cache controller responds by issuing control signals to effect the same time-staggered row activations, tag compare (yielding a cache hit in this example), RMW and column access operations within the BG0/1.1 bank pair as were previously executed with respect to the BG0.0/BG1.0 bank pair, thereby effecting back-to-back cache line transmissions over the DQ bus—transmitting initial and trailing halves of the BG0.0/BG1.0 cache line as shown at 197 and 199, and then transmitting the leading and trailing halves of the BG0.1/BG1.1 cache line at 255 and 257 Though not specifically shown, the host processor may issue a stream of cache access requests with the timing shown in FIG. 7 to effect sustained cache line access, maintaining any number of successive cache line transfers over the DQ path (i.e., without gap or timing bubble) and thus maintain cache line traffic at the DQ peak bandwidth supported by the counterpart data signaling interfaces within the host processor and CDRAM. Cache write traffic (including cache lines transmitted in association with cache fill commands—commands to load cache lines for which one or more ways are known to be available for cache line storage without evicting a resident cache line) may similarly be scheduled so as to maximize available bandwidth on the DQ bus.

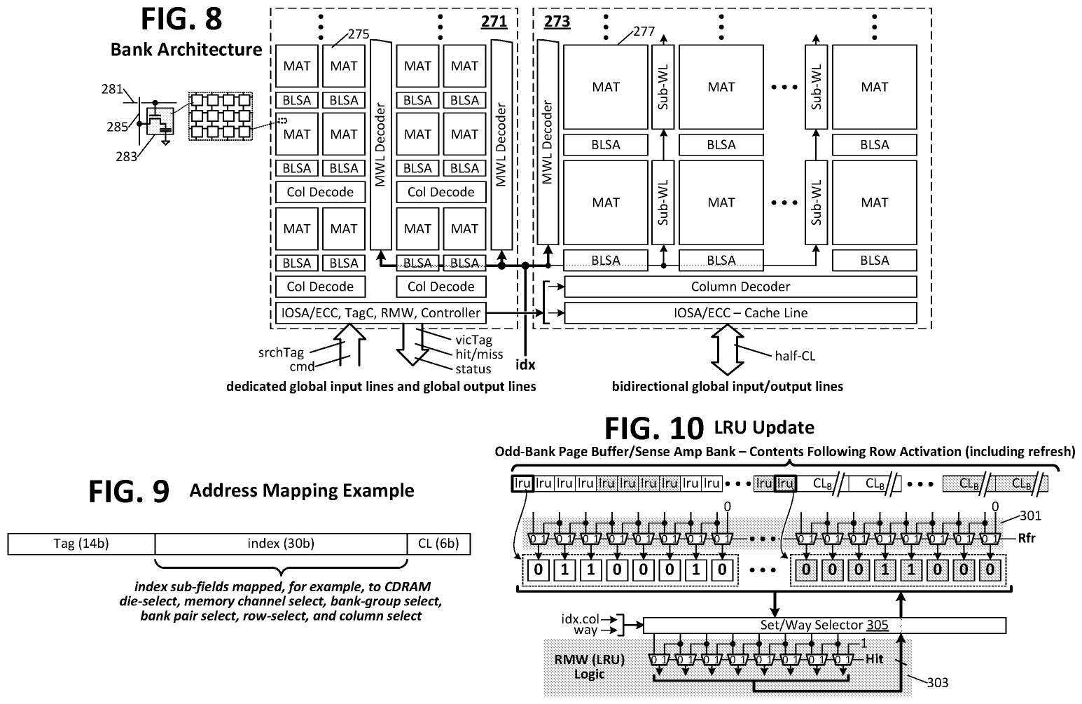

FIG. 8 illustrates an embodiment of a CDRAM (in part) having a heterogenous DRAM core architecture. More specifically, a vector-storage array 271 within the DRAM core (i.e., region of the DRAM core sized and dedicated for hit-assessment vector storage or cache-line replacement vector storage) is specially architected to achieve high-speed (low-latency) row activation and column access operations, while a cache-line array 273 (another region of the DRAM core sized and dedicated for cache line fragment storage) is architected to maximize storage density. In the depicted example, for instance, the vector-storage array is constituted by relatively small mats 275 of DRAM cells (e.g., sized at 50%, 25%, 10% of mats 277 within the cache line array) and thus relatively short (and therefore reduced capacitance and time-of-flight) bit lines 279 between the mats and block-level sense amplifiers (BLSAs) and correspondingly short/low-capacitance mat word lines 281 (asserted by major word line decoders “MWL Decoder” to switchably couple an intra-mat row of DRAM cells 283 to block-level bit lines 285). The block sense amplifiers (which may constitute an address-selectable set of page buffers in some embodiments) and column decoders (“Col Decode”) within vector-storage array 271 shrink with the reduced mat sizes and thus provide for more rapid data sensing (reducing row activation time) and column access operations than in conventional capacity-optimized DRAM architectures—all such latency-reducing characteristics reducing the row cycle time in some embodiments to fewer than 20 nanoseconds (nS), or fewer than 10 nS, 8 nS or less, and reducing column access operations to a nanosecond or less—in some implementations yielding a row cycle time (tRC) within the vector-storage array less than 75% (or 55%, 25%, 10% or yet smaller percentage) of the cache-line array tRC. Also (or alternatively), individual DRAM cells (283) within vector-storage array 271 may be enlarged relative to sizing achievable in a given fabrication process (and enlarged relative to cell size within cache-line array 273), increasing per-cell output drive strength so as to more rapidly charge or discharge bit lines 285 (i.e., enabling more rapid sensing of stored logic state) and thereby further reduce (or constitute a primary manner of reducing) row activation latency. Also, as discussed above, dedicated global input and global output lines are provided with respect to the vector-storage array (enabling concurrency between command/search-tag input and search result output) while a bidirectional set of global input/output lines are provided with respect to the cache-line array to limit the footprint (area consumption, metallization, etc.) of I/O circuitry required to convey the higher data-depth cache line fragments (i.e., 32B cache line fragment vs. 2B or 3B transfer with respect to the vector-storage array).

FIG. 9 illustrates an exemplary mapping of tag and index fields of a 50-bit (pebibyte) address that may be applied in various CDRAM embodiments herein. In the depicted example, a 44-bit cache-line address is issued by the host processor (the least significant 6 bits of the pebibyte address being unused in the case of 64B cache line granularity), including a 14-bit tag address (the search tag in a cache read or write request) and 30 bit index. The index field may be viewed has having a number of sub-fields that are applied, for example and without limitation, to select among:
multiple CDRAM installations and/or multiple CDRAM dies (e.g., a three-dimensional stack or other packaging of CDRAM dies each implementing a respective CDRAM instance),
multiple memory channels (e.g., where a given CDRAM includes multiple discrete memory access channels each including the DQ, CA and HM signaling paths shown in FIG. 1),
multiple bank-groups (e.g., selecting one of the N/2 bank-group pairs shown in detail view 115 of FIG. 1)
multiple bank pairs within a given bank-group pair (e.g., selecting one of the M bank pairs within a given bank-group pair shown in detail view 115 of FIG. 1)
multiple DRAM rows per selected bank pair (e.g., “idx. row”—the row to be activated within each bank of the selected bank pair); and
multiple tag set columns per selected row (e.g., “idx.col,” applicable where set associativity is less than total number of cache line fragments per activated row).

Smaller or larger cache-line addresses and constituent address fields may apply in alternative CDRAM embodiments or configurations (e.g., 40-bit physical memory address—of which the most-significant 34 bits constitute a cache-line address—having 8b-14b tag field and 26b-20b index field), and likewise different cache line sizes may apply (e.g., 128B or 32B cache line so that the least significant seven bits or five bits, respectively, of a byte-resolution memory address are omitted from the cache line address issued by the host processor), column-select bits (idx.col) may be unneeded where each activated row contains a number of cache line fragments corresponding to the CDRAM set associativity, the number of DRAM banks ganged to store constituent fragments of a cache line may be greater than two (e.g., four or eight DRAM banks subject to tied-access in response to a given cache read or write request, each storing a respective quarter fragment or one-eighth fragment of a complete cache line), etc. Also, to enable applicability in a wide variety of systems the address size and mapping within various CDRAM embodiments may be programmable—for example, the host processor may issue instruction and operating-mode data to the CDRAM (which responds, in turn, by programming the operating-mode data within one or more internal registers) to control application of addresses supplied with cache access requests and configure CDRAM circuitry that operates on those addresses.

FIG. 10 illustrates an embodiment of LRU update circuitry that may be deployed within the various CDRAM implementations presented herein. In the depicted example, LRU fields within odd-bank memory pages are left-shifted by multiplexers 301 at every refresh (effectively a row-activation and precharge with no data read or write), inserting a zero into the right-most bit position (when refresh-control signal “Rfr” is asserted) so that after N refresh intervals without access to a given cache line (N being the bit-depth of the LRU field, shown for example and without limitation to be an eight-bit field in the FIG. 10 implementation), the LRU field for that cache line will be completely cleared (all ‘0’s). Conversely, any cache hit within the CDRAM renders the LRU value for the matching way within the tag set specified by idx.col to the RMW engine which includes logic circuitry 303 to perform the counterpart operation of left-shifting the LRU value with logic ‘1’ insertion into the rightmost bit position and writing the modified LRU value back to the open page buffer (i.e., via set/way selector 305). By this operation, the LRU value of a cache line accessed N times between refresh intervals (typically on the order of 20 mS, though shorter or longer refresh intervals may apply) will show all ‘1’s. Accordingly, LRU fields for all cache lines in the CDRAM are progressively cleared over a sequence of refresh intervals while the LRU fields for cache lines accessed in a cache read or write hit are progressively set so that less recently used cache lines will have LRU fields of lower numeric value (e.g., taking the rightmost bit of the LRU field to be the most significant bit—order of bit shifting and logic ‘0’/‘1’ insertion point may be reversed in alternative embodiments so that the leftmost LRU bit is the most significant bit) than more recently used cache lines thus enable LRU way determination via arithmetic (inequality) comparison. In other embodiments, LRU assessment may be implemented by identifying the LRU field (within the idx. col-specified tag set) with fewest number of logic ‘1’ bits, or any other practicable manner of selecting a specific way using the LRU data. More generally, various alternative cache-line replacement mechanisms may be implemented to identify victim cache lines (e.g., most-recently used, pseudo-least recently used, etc.), including schemes for tracking cache line access without refresh-based LRU updates. Also, the odd-bank page buffer is depicted in FIG. 10 as containing a continuous collection of 8-bit LRU fields for purposes of example only. In actual implementation, the LRU field may include practicable any number (N) of bits and the LRU field itself may constitute only part of the per-cache line replacement vector (e.g., each replacement vector may additionally include, for example and without limitation, ECC information and one or more other entry-status/characterizing bits, such as validity bit, dirty bit, etc.).

The various cache architectures, operational sequences, constituent circuits, etc. disclosed herein in connection with split-entry DRAM cache embodiments may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit, layout, and architectural expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, computer storage media in various forms (e.g., optical, magnetic or semiconductor storage media, whether independently distributed in that manner, or stored “in situ”in an operating system).

When received within a computer system via one or more computer-readable media, such data and/or instruction-based expressions of the above described circuits and device architectures can be processed by a processing entity (e.g., one or more processors) within the computer system in conjunction with execution of one or more other computer programs including, without limitation, net-list generation programs, place and route programs and the like, to generate a representation or image of a physical manifestation of such circuits and architectures. Such representation or image can thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the disclosed embodiments. In some instances, the terminology and symbols may imply details not required to practice those embodiments. For example, any of the specific numbers of integrated circuit components, interconnect topologies, physical signaling interface implementations, numbers of signaling links, bit-depths/sizes of addresses, numbers of cache line fragments per cache line entry (and thus number of split-entry storage banks), cache line sizes, hit-assessment/cache-line replacement vector contents and/or bit depths, cache request/response protocols, etc. may be implemented in alternative embodiments differently from those described above. Signal paths depicted or described as individual signal lines may instead be implemented by multi-conductor signal buses and vice-versa and may include multiple conductors per conveyed signal (e.g., differential or pseudo-differential signaling). The term “coupled” is used herein to express a direct connection as well as a connection through one or more intervening functional components or structures. Programming of operational parameters (e.g., cache replacement policies, optional cache and/or snoop filter operations, and so forth) or any other configurable parameters may be achieved, for example and without limitation, by loading a control value into a register or other storage circuit within above-described integrated circuit devices in response to a host instruction and/or on-board processor or controller (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operation aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. A dynamic random access memory (DRAM) cache comprising:
a signaling interface to receive a cache access request;
a DRAM array; and
control circuitry to:
access first and second storage banks within the DRAM array in response to the cache access request to render first and second memory pages into respective sets of sense amplifiers within the first and second storage banks;
compare a search tag supplied with the cache access request with address tags stored within the first memory page to determine a cache hit/miss result; and
access respective portions of a cache line entry within the first and second memory pages if the cache hit/miss result indicates a cache hit.

2. The DRAM cache of claim 1 wherein the control circuitry to access the first and second storage banks within the DRAM array comprises circuitry to execute time-staggered row activation operations within the first and second storage banks in response to the cache access request.

3. The DRAM cache of claim 2 wherein the control circuitry to compare the search tag with address tags stored within the first memory page comprises circuitry to commence comparison of the search tag with the address tags prior to completing execution of the row activation operation within the second storage bank.

4. The DRAM cache of claim 1 wherein the control circuitry to access respective portions of a cache line entry within the first and second memory pages comprises circuitry to access a first half of the cache line entry within the first memory page and a second half of the cache line entry within the second memory page.

5. The DRAM cache of claim 1 wherein the control circuitry to access respective portions of the cache line entry within the first and second memory pages comprises circuitry to read respective portions of a cache line out of the first and second memory pages in back-to-back intervals such that a first portion of the cache line and a second portion cache line are output via a data input/output portion of the signaling interface of the DRAM cache in a continuous data burst.

6. The DRAM cache of claim 1 wherein the control circuitry to access respective portions of the cache line entry within the first and second memory pages comprises circuitry to:
receive first and second portions of a cache line via a data input/output portion of the signaling interface in a continuous data burst;
write the first portion of the cache line into a first portion of the cache line entry within the first memory page; and
write the second portion of the cache line into a second portion of the cache line entry within the second memory page.

7. The DRAM cache of claim 1 wherein cache line entry comprises two halves, including a first half within the first memory page and a second half within the second memory page.

8. The DRAM cache of claim 1 wherein the control circuitry comprises circuitry to obtain recency data for a plurality of cache lines corresponding to the cache access request from the second memory page and to identify, using the recency data and from among the plurality of cache lines, a victim cache line to be overwritten within the DRAM cache if the cache hit/miss result indicates a cache miss.

9. The DRAM cache of claim 8 wherein the control circuitry to identify the victim cache line if the cache hit/miss result indicates a cache miss comprises circuitry to:
obtain, from the first memory page, coherency values that correspond respectively to the plurality of cache lines;
determine, based at least in part on the coherency values, whether the victim cache line is to be output from the DRAM cache prior to being overwritten; and
if the victim cache line is to be output from the DRAM cache prior to being overwritten, retrieve respective portions of the victim cache line from the first and second memory pages and output the respective portions of the victim cache line from the DRAM cache.

10. The DRAM cache of claim 1 wherein the first memory page includes storage for N tag address values and N cache line fragments, N being an integer greater than one.

11. The DRAM cache of claim 10 wherein the control circuitry to access respective portions of the cache line entry within the first and second memory pages if the cache hit/miss result indicates a cache hit comprises circuitry to:
select a subset of the N tag address values based on a sub-field of an address received as part of the cache access request;
compare the subset of the N tag address values with the search tag to generate a way address; and
access the respective portion s of the cache line entry within the first and second memory pages using the way address.

12. A method of operation within a dynamic random access memory cache (DRAM cache), the method comprising:
accessing first and second storage banks within a DRAM array in response to a cache access request to render first and second memory pages into respective sets of sense amplifiers within the first and second storage banks;
comparing a search tag supplied with the cache access request with address tags stored within the first memory page to determine a cache hit/miss result; and
accessing respective portions of a cache line entry within the first and second memory pages if the cache hit/miss result indicates a cache hit.

13. The method of claim 12 wherein accessing the first and second storage banks within the DRAM array comprises executing time-staggered row activation operations within the first and second storage banks in response to the cache access request.

14. The method of claim 13 wherein comparing the search tag with address tags stored within the first memory page comprises commencing comparison of the search tag with the address tags prior to completing execution of the row activation operation within the second storage bank.

15. The method of claim 12 wherein accessing respective portions of a cache line entry within the first and second memory pages comprises accessing a first half of the cache line entry within the first memory page and a second half of the cache line entry within the second memory page.

16. The method of claim 12 wherein accessing respective portions of the cache line entry within the first and second memory pages comprises reading respective portions of a cache line out of the first and second memory pages in back-to-back intervals such that a first portion of the cache line and a second portion cache line are output from DRAM cache in a continuous data burst.

17. The method of claim 12 wherein accessing respective portions of the cache line entry within the first and second memory pages comprises:
receiving first and second portions of a cache line via a data interface of the DRAM cache in a continuous data burst;
writing the first portion of the cache line into a first portion of the cache line entry within the first memory page; and
writing the second portion of the cache line into a second portion of the cache line entry within the second memory page.

18. The method of claim 12 wherein the cache line entry comprises two halves, including a first half within the first memory page and a second half within the second memory page.

19. The method of claim 12 wherein DRAM cache has a native data input/output bit depth less than the bit depth of a cache line stored within the cache line entry.

20. The method of claim 12 further comprising obtaining recency data for a plurality of cache lines corresponding to the cache access request from the second memory page and identifying, using the recency data and from among the plurality of cache lines, a victim cache line to be overwritten within the DRAM cache if the cache hit/miss result indicates a cache miss.

21. The method of claim 20 wherein identifying the victim cache line if the cache hit/miss result indicates a cache miss comprises:
obtaining, from the first memory page, coherency values that correspond respectively to the plurality of cache lines;
determining, based at least in part on the coherency values, whether the victim cache line is to be output from the DRAM cache prior to being overwritten; and
if the victim cache line is to be output from the DRAM cache prior to being overwritten, retrieving respective portions of the victim cache line from the first and second memory pages and outputting the respective portions of the victim cache line from the DRAM cache.

22. The method of claim 12 wherein the first memory page includes storage for N tag address values and N cache line fragments, N being an integer greater than one, and wherein accessing respective portions of the cache line entry within the first and second memory pages if the cache hit/miss result indicates a cache hit comprises:
selecting a subset of the N tag address values based on a sub-field of an address received by the DRAM cache as part of the cache access request;
comparing the subset of the N tag address values with the search tag to generate a way address; and
accessing the respective portion s of the cache line entry within the first and second memory pages using the way address.

23. A dynamic random access memory (DRAM) cache comprising:
a signaling interface to receive a cache access request;
a DRAM array;
means for accessing first and second storage banks within the DRAM array in response to the cache access request to render first and second memory pages into respective sets of sense amplifiers within the first and second storage banks;
means for comparing a search tag supplied with the cache access request with address tags stored within the first memory page to determine a cache hit/miss result; and
means for accessing respective portions of a cache line entry within the first and second memory pages if the cache hit/miss result indicates a cache hit.
